(19) United States
(12) Patent Application Publication
(10) Pub. No.: US 2010/0210435 A1
(43) Pub. Date: Aug. 19, 2010

(54) ADAPTABLE FOAM ROLLER

(76) Inventor: Gregory J. Isaac, Coto De Caza, CA (US)

Correspondence Address: STETINA BRUNDA GARRED & BRUCKER, 75 ENTERPRISE, SUITE 250, ALISO VIEJO, CA, 92656, US

(21) Appl. No.: 12/771,728

(22) Filed: Apr. 30, 2010

Related U.S. Application Data
(63) Continuation of application No. 11/124,564, filed on May 6, 2005.

(51) Int. Cl. B05C 17/02; B23P 11/00

(52) U.S. Cl. 492/55; 29/428; 15/230

(57) ABSTRACT

A composite paint roller is provided for improving ease of cleaning, manufacture and adaptability of the same. The roller comprises an elongate cylindrical core, a sheath, and first and second end caps. The sheath is removably mountable about and frictionally engageable to the core. The core defines a core length and opposing open ends. The sheath defines an axial length and opposing sheath ends. The axial length of the sheath is greater than the core length with the opposing sheath ends being foldable and axially insertable into the opposing open ends to produce a radial compression of the sheath adjacent the opposing open ends. The radial compression creates opposing beveled ends of the roller. The first and second end caps each are attachable to the opposing open ends to secure the opposing sheath ends within the opposing open ends.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to painting tools. More specifically, the present invention is directed to a composite foam/fabric roller for improving the ease of cleaning, manufacture, and adaptability of the roller.

There is currently known in the art a wide variety of products and processes for applying paint, varnish, adhesives and other coatings (collectively referred to herein as “paint”). These products may include, inter alia, spray guns, fabric rollers, bristle hair brushes, and rollers and brushes fabricated from foam materials. Generally, these products come in a variety of sizes and configurations in order to accommodate different needs based on application requirements. For example, a paint roller may vary in length, such as 3″, 4″, 6″, 7″ or 9″, and may also be available in varying diameters. In addition, the roller may be made of various types of foam or fabrics, each specific type providing a related advantage for a particular application.

The state-of-the-art has advanced to provide paint rollers including several sizes, materials, and configurations. However, it appears that the fundamental model of the paint roller has changed very little. Therefore, many of the disadvantages that existed with traditional paint rollers still exist among many of the current rollers. Specifically, some of the disadvantages include the difficulty of manufacturing the rollers, deliberations associated with selection and purchase of rollers, and the difficulty of properly cleaning a roller in order to reuse it. Indeed, several disadvantages appear to be unaddressed by current paint roller technology.

First, a given paint roller is generally manufactured utilizing a process of creating a foam or fabric cover, overlaying or wrapping the cover onto a cylindrical core, adhering the cover to the core utilizing glue or other adhesives, and beveling the edge at each of the distal ends of the roller. The adhering and beveling steps in this process typically require additional material or equipment in order to execute these steps. Further, these additional steps in the manufacturing process increase the production time. Nevertheless, despite the additional expenses and time requirements, manufacturers continue to produce rollers that are adhesively connected to the roller and that have manually beveled edges.

Additionally, in preparing for a painting job, users must carefully determine which roller configuration best suits a given application and then purchase the necessary configurations and quantities. Frequently, a painting job may require several rollers of varying size. Therefore, users may be required to purchase multiple rollers in order to be well prepared for painting. The requirement of purchasing multiple specifically-suited rollers often results in additional cost to users.

Finally, paint roller technology also appears to have changed very little with regard to roller cleaning requirements. In general, after using a paint roller with either a water or oil based paint or other coating, users must first scrape out any excess paint into a paint can or tray, and then wet the roller with water or suitable solvent to the roller, wring out the roller, and repeat the wetting and wringing steps until the rinsing water or solvent is nearly clear. Alternatively, one may spin the roller using water from a hose. Such a process may be somewhat easier and more effective than its alternatives, but it typically fails to completely remove all of the paint from the roller and often leads to a very wet and messy result. Of particular significance, rollers are difficult to thoroughly clean at the innermost part of the foam or the fabric where the foam or fabric meets the core. Unless this problem area is cleaned, paint residue remains on the roller and may contribute to reduced roller life, poor performance, and poor durability of the roller in subsequent painting jobs.

Therefore, there exists a need in the art for an improved paint roller that enhances the ease of manufacture and provides an improved configuration that allows a user to adapt or modify the roller in accordance with size requirements for a variety of applications. Finally, there exists a need in the art for an improved paint roller that facilitates easy and thorough cleaning.

### BRIEF SUMMARY OF THE INVENTION

In accordance with an embodiment of the present invention, a composite paint roller is provided for improving ease of cleaning, manufacture and adaptability. The roller comprises an elongate cylindrical core, a sheath, and first and second end caps. The core is preferably formed having a tubular configuration and defines a core length and opposing open ends. The sheath is removably mountable about the core and defines an axial length and opposing sheath ends. The axial length of the sheath is preferably greater than the core length with the opposing sheath ends being foldable and axially insertable into the opposing open ends. The first and second end caps each are attachable to the opposing open ends to secure the opposing sheath ends within the opposing open ends.

In accordance with an aspect of the present invention, the sheath is preferably fabricated from a resilient material. Due to the resiliency of the sheath, insertion of the sheath into the opposing open ends facilitates and produces a radial compression of the sheath adjacent the opposing open ends. The radial compression of the sheath results in the creation of opposing beveled ends of the roller.

The sheath may also define a sheath inner surface and a sheath inner diameter. The core may further define a core outer surface and a core outer diameter. In one implementation, the sheath inner diameter may be less than the core outer diameter, and the sheath may be stretchable to axially slide onto the core with the sheath inner surface being frictionally engageable to the core outer surface. In this regard, the sheath may not adhesively affixed to the core.

The core may preferably be a hollow tubular core. The first and second end caps may each define a cap periphery including a plurality of radially-spaced tooth projections. The tooth projections of each cap may be sized and configured to radially compress the opposing sheath ends within the opposing open ends.

In accordance with another implementation of the present invention, a composite paint roller is provided for improving ease of cleaning, manufacture and adaptability. The roller comprises an elongate cylindrical core defining a core outer diameter, a core outer surface, a core length, and opposing open ends; a sheath being removably mountable about the core and being fabricated from a resilient material, the sheath defining a sheath inner diameter, a sheath inner surface, an axial length, and opposing sheath ends, the sheath inner diameter being less than the core outer diameter with the sheath being stretchable to axially slide onto the core with the sheave inner surface being frictionally engaged to the core outer surface, the axial length being greater than the core length with the opposing sheath ends being foldable and axially insertable into the opposing open ends to produce a radial compression of the sheath adjacent the opposing open ends, the radial compression creating opposing beveled ends of the roller; and first and second end caps each being attachable to the opposing open ends to secure the opposing sheath ends within the opposing open ends, the first and second end caps each defining a cap periphery including a plurality of radially-spaced tooth projections, the tooth projections of each cap being sized and configured to radially compress the opposing sheath ends within the opposing open ends.

According to another embodiment of the present invention, a method is provided for utilizing a composite paint roller. The roller includes an elongate cylindrical core, a sheath, and first and second end caps. The core defines a core length and opposing open ends. The sheath defines an axial length and opposing sheath ends. The axial length may be greater than the core length. The first and second end caps may each be attachable to the opposing open ends. The method comprises the steps of: overlaying the sheath upon the core; inserting the opposing sheath ends within the opposing open ends; and attaching the first and second end caps to the open ends with the opposing sheath ends being secured to the opposing open ends.

In another implementation of the method, the sheath defines a sheath inner surface and a sheath inner diameter, and the core further defines a core outer surface and a core outer diameter. The sheath inner diameter is less than the core outer diameter, and the sheath is stretchable to axially slide onto the core. Thus, the overlaying step of the method may further include: sliding the sheath axially onto the core with the sheath inner surface being frictionally engaged to the core outer surface.

In an implementation of the method, the sheath is fabricated from a resilient material. The inserting step may further include forming opposing beveled ends upon insertion of the opposing sheath ends into the opposing open ends. Insertion of the opposing sheath ends facilitates a radial compression of the resilient sheath adjacent the opposing open ends. This radial compression creates the opposing beveled ends of the roller.

The method may further comprise the step of shortening the core to a desired length. The method may also comprise the steps of: removing the first and second securing caps from the respective ones of the opposing open ends; and removing the sheath from the core. In this regard, the method may further comprise the step of cleaning the sheath.

### BRIEF DESCRIPTION OF THE DRAWINGS

An illustrative and presently preferred embodiment of the invention is shown in the accompanying drawings in which:

FIG. 1 is a perspective view of a composite paint roller constructed in accordance with an embodiment of the present invention which is configured for use with a conventional roller assembly;

FIG. 2 is an exploded view of a composite paint roller including a core, a sheath, and first and second end caps;

FIG. 3 is a cross-sectional view of the roller showing an embodiment wherein opposing sheath ends are secured at the respective ones of opposing open ends of the core utilizing the first and second end caps;

FIG. 4 is a cross-sectional view showing the core which has been shortened to a desired length;

FIG. 5 is a perspective view of the roller wherein the sheath has been configured to include a decorative pattern;

FIG. 6 is a block diagram illustrating an embodiment of a method of utilizing a composite paint roller; and

FIG. 7 is a block diagram illustrating another embodiment of the method.

FIG. 8 is a block diagram illustrating another embodiment of the method.

### DETAILED DESCRIPTION OF THE INVENTION

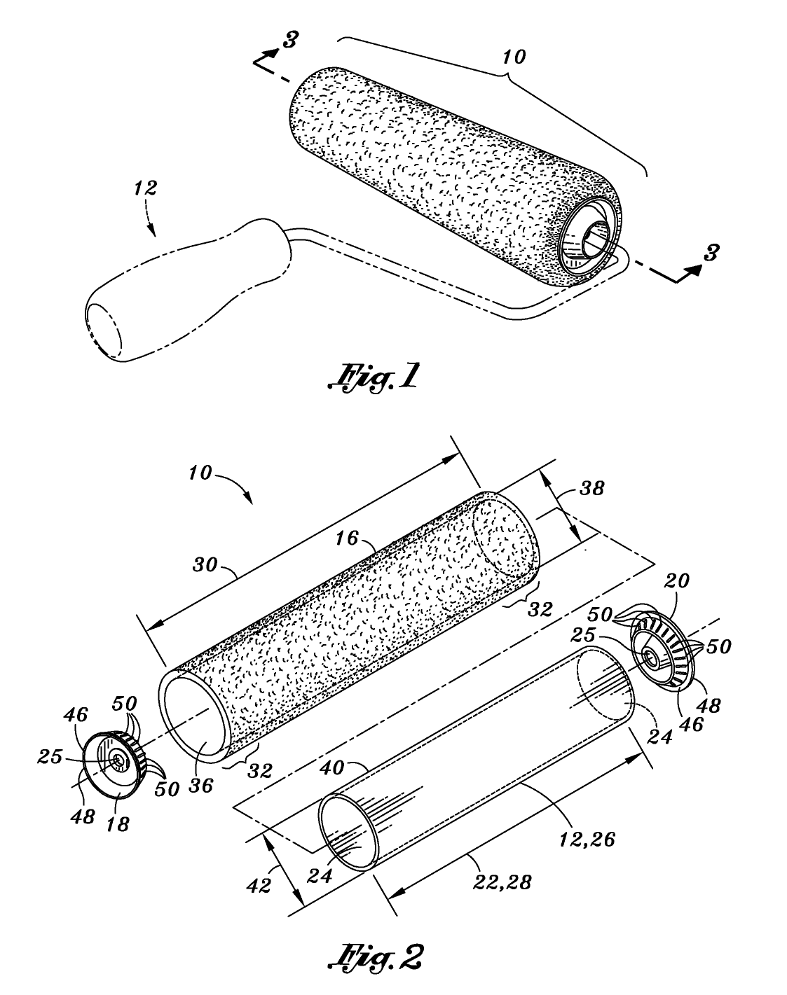

Referring now to the drawings wherein the showings are for purposes of illustrating the preferred embodiments of the present invention only and not for purposes of limiting the same, FIG. 1 is a perspective view of a composite paint roller 10 attached to a paint roller assembly 12. According to various aspects of the present invention, the roller is provided for improving ease of cleaning, manufacturing and adaptability of the same. The roller comprises an elongate cylindrical core 14, a sheath 16, and first and second end caps 18, 20.

Referring now to FIG. 1, the core is preferably formed having a tubular configuration and defines a core length 22 and opposing open ends 24. In an embodiment shown in FIGS. 2-4, the core may be a hollow tubular core 26. However, in other embodiments of the present invention, the core may be a solid core, or variations thereof (such as incorporating internal structural members). Additionally, the core may be manufactured having various lengths and/or diameters. For example, the core may be fabricated having conventional core lengths such as six, eight, or ten inches.

An advantageous aspect associated with an embodiment of the present invention is that the core may be shortened to a desired length 28. Depending on the core configuration, a user may cut or disassemble the core in order to shorten the core. In an exemplary embodiment, the core may be fabricated from a cardboard or plastic material that may easily be cut by the user with an appropriate cutting device, such as scissors, an Exacto knife, or a hand saw. In another exemplary embodiment, the core may be configured as multiple interconnectable segments. For example, the core may include three interconnectable three inch wide segments, although any number of segments and any length may be possible. Thus, if the user desires to shorten the length of the core, the user may remove one of the segments from the core and thereby adjust the core to the desired length 28. In yet another exemplary embodiment, the core may be configured as an integral telescoping core. In this regard, the user may be able to adjust the core to various lengths utilizing a telescoping mechanism of the core itself.

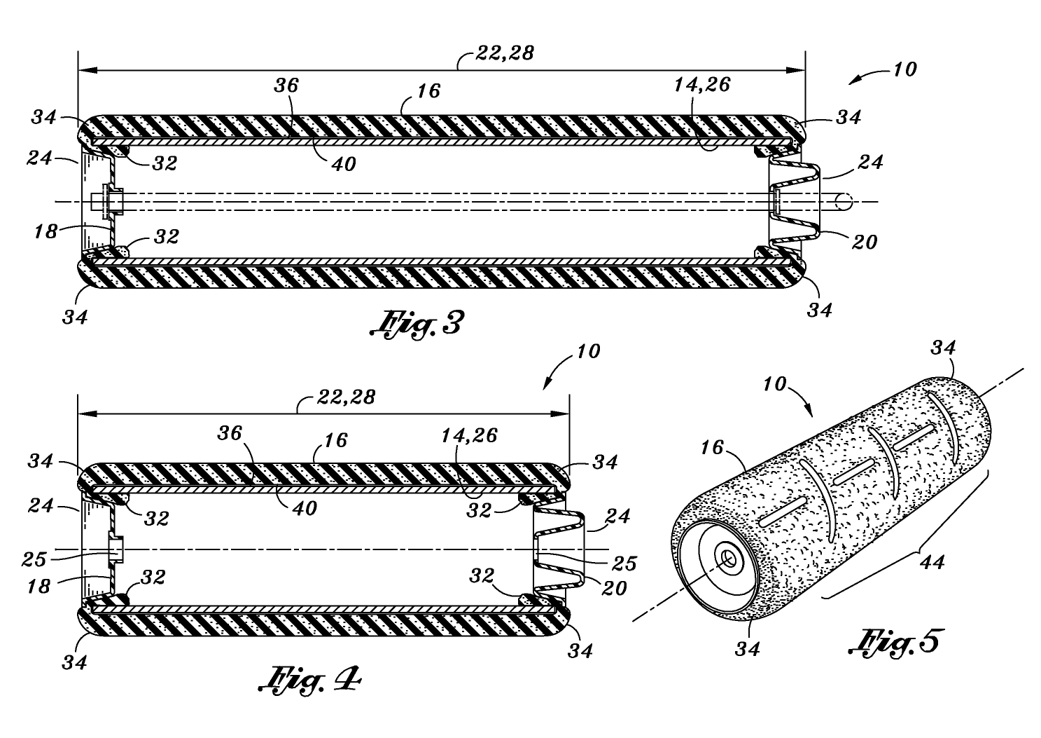

According to an implementation of the present invention, the sheath 16 is removably mountable about the core and defines an axial length 30 and opposing sheath ends 32. Referring to FIG. 2, the axial length 30 of the sheath 16 is preferably greater than the core length 22 such that the opposing sheath ends 32 extend beyond the respective ones of the opposing open ends 24. As illustrated in FIGS. 3 and 4, the portion of the opposing sheath ends 32 that extends beyond the opposing open ends 24 may be foldable and axially insertable into the opposing open ends 24. The opposing sheath ends 32 may be defined as that portion of the sheath 16 as it approaches the respective distal ends of the sheath 16, which may be effectively inserted into the opposing open ends 24. In some cases, the amount of sheath 16 inserted into the opposing open ends 24 may be substantial, and in other cases, the amount may be insubstantial. For example, if the user opts to use a shorter desired length 28 of the core, but does not desire to cut the sheath 16 correspondingly, the user may simply insert as much sheath 16 as needed into the opposing open ends 24. This advantageous aspect of the present invention allows the sheath 16 to be properly fitted to the core each time the roller is modified to various desired lengths without effecting permanent alteration of the sheath 16. The user may easily adjust the roller as required without purchasing multiple sheaths.

In accordance with an aspect of the present invention, the sheath 16 is preferably fabricated from a resilient material. The sheath 16 may preferably be fabricated from a foam material, however, it is contemplated that many other materials may provide similar advantageous properties, including and not limited to resiliency. Due to the resiliency of the sheath 16, insertion of the sheath 16 into the opposing open ends 24 facilitates and produces a radial compression of the sheath 16 adjacent the opposing open ends 24, which results in the creation of opposing beveled ends 34 of the roller. Thus, another advantageous aspect of the present invention is the self-beveling of the roller. The beveled edge may serve to prevent undesirable overlap may occur during painting. Traditional paint rollers typically accumulate excess paint along their opposing ends which results in glob overlap during painting. Although some traditional rollers have a beveled edge, the edge must be created utilizing a separate manufacturing step. However, the self-beveling aspect of the present invention obviates the need for a separate beveling step in the present-day manufacture of paint rollers. Thus, this advantageous aspect of the present invention allows for reduction of manufacturing time and expenses.

Referring again to FIG. 2, the sheath 16 may also define a sheath inner surface 36 and a sheath inner diameter 38. The core may further define a core outer surface 40 and a core outer diameter 42. In one implementation, the sheath inner diameter 38 may be less than the core outer diameter 42, and the sheath 16 may be stretchable to axially slide onto the core with the sheath inner surface 36 being frictionally engageable to the core outer surface 40. In this regard, the sheath 16 may not adhesively affixed to the core. Therefore, manufacture of an embodiment of the present invention may be much easier, faster, and cheaper than manufacture of traditional rollers. Additionally, the sheath 16 need not be made in conjunction with the core, and may even be manufactured in different facilities and both may be sold separately.

It is contemplated that another manufacturing benefit may be the ease of interchangeability of various sheaths with a single core. For example, the user may purchase replacement sheaths or sheaths of differing textures. Then the user may interchange the sheaths upon the single core as desired, and adjust the length of the core as necessary. Thus, the user may enjoy the versatility and benefit of using a single adjustable core with any number of desired sheaths.

Embodiments of the present invention also provide greater ease of cleaning due to the complete removability of the sheath 16 from the core. After painting, the user may remove the sheath 16 and soak the sheath 16 in water or suitable solvent and wring it out completely. Indeed, traditional rollers are problematic because paint residue often remains on the roller where the sheath 16 meets the core, which limits service life, performance, and durability. However, because embodiments of the present invention allow the sheath 16 to be completely removed from the core, both the sheath 16 and the core may be thoroughly cleaned. The sheath 16 may therefore enjoy longer service life, consistent quality, and greater durability.

Referring now to FIG. 5, the sheath 16 may be altered by the user in order to create a desired decorative pattern 44. According to an exemplary embodiment of the present invention, the sheath 16 may be removed from the core in order to allow the user to freely cut, shape, or otherwise manipulate the surface of the sheath 16. This added versatility of the sheath 16 may allow the user to develop intricate decorative pattern thereon.

In accordance with another implementation of the present invention, the first and second end caps 18, 20 each are attachable to the opposing open ends 24 to secure the opposing sheath ends 32 within the opposing open ends 24. As shown in FIG. 2, in a preferred embodiment, the first and second end caps 18, 20 may be insertable within the opposing open ends 24. Thus, upon insertion of the first and second end caps 18, 20, the opposing sheath ends 32 may also be secured to the opposing open ends 24 of the core, and as described above, the opposing beveled ends 34 of the roller may be created. However, in an alternative implementation of the present invention, the core may be of a completely solid cylindrical configuration. Thus, the first and second end caps 18, 20 may be external to the core and attachment to the opposing open ends 24 may be superficial, not internal. In such an embodiment, the opposing sheath ends 32 may likewise be externally attachable to the opposing open ends 24. In this regard, the opposing open ends 24 may be broadly defined as that portion of the distal ends of the core whereto the opposing sheath ends 32 may be affixed utilizing the first and second end caps 18, 20. Thus, the opposing open ends 24 need not be cavernous in their configuration. For example, the first and second end caps 18, 20 may be adhesive mounts, such as Velcro or other suitable attachment members, and, utilizing the first and second end caps 18, 20, the opposing sheath ends 32 may be secured to the opposing open ends 24 external to the core and facilitate the creation of the opposing beveled ends 34 of the roller.

According to yet another aspect of the present invention, the first and second end caps 18, 20 may each define a cap periphery 48 including a plurality of radially-spaced tooth projections 50, as shown in FIG. 2. Upon being inserted into the respective ones of the opposing open ends 24, the tooth projections 50 of each of the first and second end caps 18, 20 may be sized and configured to radially compress the opposing sheath ends 32 within the opposing open ends 24. It is contemplated that the dimensions of the tooth projections 50 may be optimized based on the material used for the sheath 16, the thickness of the sheath 16, as well as dimensions of the core and the first and second end caps 18, 20 themselves. Design optimization of the tooth projections 50 may allow the opposing sheath ends 32 to be sufficiently compressed and constrained at the opposing open ends 24 such that the sheath 16 and the opposing beveled ends 34 of the roller maintain their fit during use. In addition, the first and second end caps 18, 20 may also include ridges 46 about the respective ones of the cap peripheries in order to facilitate removal of the first and second end caps 18, 20 from the respective ones of the opposing open ends 24.

According to an aspect of the present invention, the first and second end caps 18, 20 may be fabricated from a plastic material. As shown in FIGS. 3 and 4, the first and second end caps 18, 20 need not be identical in their configuration. It is contemplated that at least one of the first and second end caps 18, 20 may be specially configured to facilitate engagement with the paint roller assembly 12, as shown in FIG. 2. Therefore, according to an embodiment of the present invention, the first and second end caps 18, 20 may be formed as shown in FIGS. 2 and 4.

In accordance with yet another implementation of the present invention, a composite paint roller 10 is provided for improving ease of cleaning, manufacture and adaptability of the same. The roller comprises an elongate cylindrical core 14 defining a core outer diameter 42, a core outer surface 40, a core length 22, and opposing open ends 24; a sheath 16 being removably mountable about the core and being fabricated from a resilient material, the sheath 16 defining a sheath inner diameter 38, a sheath inner surface 36, an axial length 30, and opposing sheath ends 32, the sheath inner diameter 38 being less than the core outer diameter 42 with the sheath 16 being stretchable to axially slide onto the core with the sheath inner surface 36 being frictionally engaged to the core outer surface 40, the axial length 30 being greater than the core length 22 with the opposing sheath ends 32 being foldable and axially insertable into the opposing open ends 24 to produce a radial compression of the sheath 16 adjacent the opposing open ends 24, the radial compression creating opposing beveled ends 34 of the roller; and first and second end caps 18, 20 each being attachable to the opposing open ends 24 to secure the opposing sheath ends 32 within the opposing open ends 24, the first and second end caps 18, 20 each defining a cap periphery 48 including a plurality of radially-spaced tooth projections 50, the tooth projections 50 of each cap being sized and configured to radially compress the opposing sheath ends 32 within the opposing open ends 24.

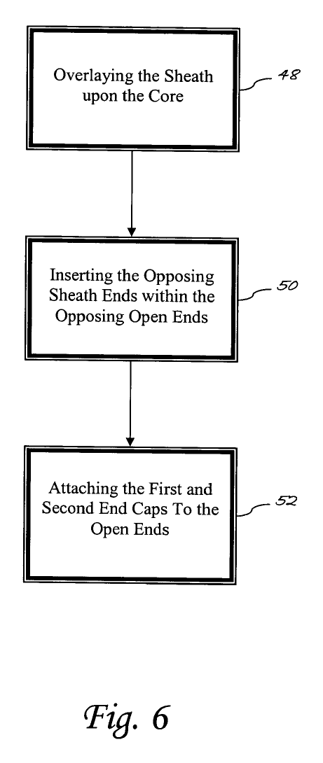

According to another embodiment of the present invention, as illustrated in FIG. 6, a method is provided for utilizing a composite paint roller 10. The roller includes an elongate cylindrical core 14, a sheath 16, and first and second end caps 18, 20. The core defines a core length 22 and opposing open ends 24. The sheath 16 defines an axial length 30 and opposing sheath ends 32. The axial length 30 may be greater than the core length 22. The first and second end caps 18, 20 may each be attachable to the opposing open ends 24. The method comprises the steps of: overlaying the sheath 16 upon the core (i.e., overlaying step 52, as shown in FIG. 6); inserting the opposing sheath ends 32 within the opposing open ends 24 (i.e., inserting step 54, as shown in FIG. 6); and attaching the first and second end caps 18, 20 to the opposing open ends 24 with the opposing sheath ends 32 being secured to the opposing open ends 24 (i.e., attaching step 56, as shown in FIG. 6).

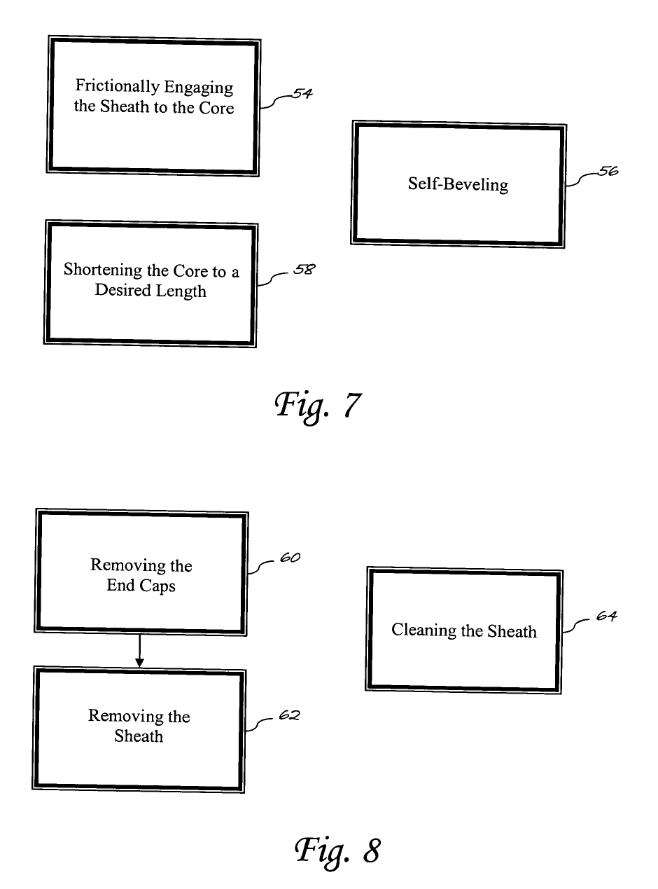

Referring now to FIG. 7 to illustrate another implementation of the method, the sheath 16 defines a sheath inner surface 36 and a sheath inner diameter 38, and the core further defines a core outer surface 40 and a core outer diameter 42. The sheath inner diameter 38 is less than the core outer diameter 42, and the sheath 16 is stretchable to axially slide onto the core. Thus, the overlaying step 52 of the method may further include: sliding the sheath 16 axially onto the core with the sheath inner surface 36 being frictionally engaged to the core outer surface 40 (i.e., frictionally engaging step 58, as shown in FIG. 7).

As illustrated in FIG. 7, yet another implementation of the method includes the sheath 16 being fabricated from a resilient material. As mentioned above, the material may be foam or another suitable resilient material. The inserting step 54 may further include forming opposing beveled ends 34 upon insertion of the opposing sheath ends 32 into the opposing open ends 24 (i.e., self-beveling step 60, as shown in FIG. 7). Insertion of the opposing sheath ends 32 facilitates a radial compression of the resilient sheath 16 adjacent the opposing open ends 24. This radial compression creates the opposing beveled ends 34 of the roller. The opposing beveled ends 34 of the roller may be preferably maintained in form via insertion of the first and second end caps 18, 20, which is accomplished in performing the attaching step 56.

The method may further comprise the step of shortening the core to a desired length 28 (i.e., shortening step 62, as shown in FIG. 7). As mentioned above, the shortening may be done by cutting the core or simply by removing segments thereof. The manner in which the core may be shortened depends on the composition and configuration of the core.

The method may also comprise the steps of removing the first and second end caps 18, 20 from the respective ones of the opposing cavities (i.e., removing the end caps step 64, as shown in FIG. 8); and removing the foam sheath 16 from the core (i.e., removing the sheath step 66, as shown in FIG. 8). As discussed above, when the sheath 16 is removed from the core, the sheath 16 may be cleaned, shortened, or a decorative pattern may be tailored on the surface of the sheath 16. In this regard, the method may also include the step of cleaning the sheath 16 (i.e., cleaning the sheath step 68, as shown in FIG. 8). The cleaning may be done utilizing a suitable solvent, and may be done by hand or mechanical means.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

1. (canceled)

2. (canceled)

3. (canceled)

4. (canceled)

5. (canceled)

6. (canceled)

7. (canceled)

8. A method of utilizing a composite foam roller, the roller including an elongate cylindrical core defining a core length and opposing open ends, a sheath defining an axial length and opposing sheath ends, the axial length being greater than the core length, and first and second end caps each being attachable to the opposing open ends, the method comprising:
a) overlaying the sheath upon the core;
b) inserting the opposing sheath ends within the opposing open ends; and
c) attaching the first and second end caps to the open ends, the end caps being engaged with the opposing sheath ends to secure the opposing sheath ends between the first and second end caps and the core, the end caps defining a rotation axis about which the roller rotates, the end caps extending radially from the sheath toward the rotation axis.

9. The method of claim 8 wherein the sheath defines a sheath inner surface and a sheath inner diameter, and the core further defines a core outer surface and a core outer diameter, the sheath inner diameter being less than the core outer diameter, the sheath being stretchable to axially slide onto the core, the overlaying step further including sliding the sheath axially onto the core with the sheath inner surface being frictionally engaged to the core outer surface.

10. The method of claim 8 wherein the sheath is fabricated from a resilient material, the inserting step further including forming opposing beveled ends defined by the sheath upon insertion of the opposing sheath ends into the opposing open ends, insertion of the opposing sheath ends facilitating a radial compression of the resilient sheath adjacent the opposing open ends, the radial compression creating the opposing beveled ends of the roller.

11. The method of claim 8 further comprising the step of shortening the core to a desired length.

12. The method of claim 8 further comprising the steps of:
a) removing the first and second securing caps from the respective ones of the opposing open ends; and
b) removing the sheath from the core.

13. The method of claim 12 further comprising the step of cleaning the sheath.

14. The method of claim 8, wherein the composite foam roller is configured for use with a paint roller assembly, wherein step c) includes first and second end caps each having a rotation aperture formed therein, the rotation aperture being sized to receive and engage the paint roller assembly.

15. The method of claim 14, wherein step c) includes first and second end caps each extending radially between the sheath and the respective rotation aperture.

16. A method of utilizing a composite foam roller, the method comprising the steps of:
a) providing a roller including:
an elongate hollow core defining a core length and opposing open ends, the core having a core outer surface independent of a paint delivery passageway extending through the core outer surface;
a sheath defining an axial length and opposing sheath ends, the axial length being greater than the core length; and
first and second end caps each being attachable to the opposing open ends, each end cap including a respective rotation aperture;
b) cutting a decorative pattern in the sheath;
c) overlaying the sheath upon the core;
d) inserting the opposing sheath ends within the opposing open ends; and
e) attaching the first and second end caps to the elongate core adjacent the open ends with the opposing sheath ends being secured to the opposing open ends, each end cap extending radially between the sheath and the rotation aperture, the position of the first and second end caps being fixed relative to the elongate core when the first and second end caps are attached to the elongate core.

17. The method of claim 16 wherein the sheath defines a sheath inner surface and a sheath inner diameter, the sheath inner diameter being less than the core outer diameter, the sheath being stretchable to axially slide onto the core, the overlaying step further including sliding the sheath axially onto the core with the sheath inner surface being frictionally engaged to the core outer surface.

18. The method of claim 16 wherein the sheath is fabricated from a resilient material, the inserting step further including forming opposing beveled ends upon insertion of the opposing sheath ends into the opposing open ends, insertion of the opposing sheath ends facilitating a radial compression of the resilient sheath adjacent the opposing open ends, the radial compression creating the opposing beveled ends of the roller.

19. The method of claim 16 further comprising the step of shortening the core to a desired length.

20. The method of claim 16 further comprising the steps of:
a) removing the first and second securing caps from the respective ones of the opposing open ends; and
b) removing the sheath from the core.

21. The method of claim 16 further comprising the step of cleaning the sheath.

22. The method of claim 16, wherein the composite foam roller is configured for use with a paint roller assembly, wherein step a) includes first and second end caps each having a rotation aperture formed therein, the rotation aperture being sized to receive and engage the paint roller assembly.

23. The method of claim 22, wherein step a) includes first and second end caps each extending radially between the sheath and the respective rotation aperture.
